(19) United States
(12) Patent Application Publication
(10) Pub. No.: US 2017/0368608 A1
(43) Pub. Date: Dec. 28, 2017

(54) INTEGRATED VIBRATION DAMPER FOR ADDITIVELY MANUFACTURED STRUCTURE AND METHOD

(71) Applicant: Sikorsky Aircraft Corporation, Stratford, CT (US)

(72) Inventors: Kenji Homma, Glastonbury, CT (US); Paul R. Braunwart, Hebron, CT (US); Daniel V. Viens, Mansfield Center, CT (US); Aaron T. Nardi, East Granby, CT (US); Michael A. Klecka, Coventry, CT (US); Jeffrey Michael Mendoza, Manchester, CT (US)

(21) Appl. No.: 15/541,650

(22) PCT Filed: Dec. 30, 2015
(86) PCT No.: PCT/US2015/068078

§ 371 Date: Jul. 5, 2017

Related U.S. Application Data
(60) Provisional application No. 62/099,724, filed on Jan. 5, 2015.

(51) Int. Cl. B22F 7/02; B22F 3/105; B33Y 10/00; B33Y 80/00; F16F 7/10; B22F 5/10

(52) U.S. Cl. CPC B22F 7/02; F16F 7/10; B22F 5/10; B33Y 10/00; B33Y 80/00; B22F 3/1055

(57) ABSTRACT

A vibration damper for an additively manufactured structure includes a structure at least partially formed with an additive manufacturing technique. Also included is a damping element embedded within the structure at an internal location of the structure. A method of damping vibration of an additively manufactured component is provided. The method includes additively manufacturing a structure. The method also includes embedding at least one damping element within the structure at an internal location of the structure.

### BACKGROUND OF THE INVENTION

The embodiments herein generally relate to vibration dampers and, more particularly, to vibration dampers for structures that are formed with additive manufacturing techniques, as well as a method of manufacturing such structures with vibration dampers therein.

The design of structural components such as beams, cases, shafts and housings, for example, are typically constrained by deflection (i.e., stiffness) and/or stress characteristics. For many applications, such as in the aerospace industry, the design is further constrained by weight and available space. Consequently, the cross section of the structure is typically minimized with respect to a volume/mass ratio and optimized to limit stress and/or strain. One potential consequence of these constraints is that a natural frequency may be excited by one of the systems forcing functions, such as shaft speed, rotor speed, and gear meshing, as examples of aerospace applications. This problem is further exacerbated by new airframe designs where structural components are high-speed machined from solid forgings instead of joined extrusions, plates, and forgings. These high speed machined structures are largely undamped due to the lack of joints. The joined assemblies are inherently damped by the nature of the joints that make up the structure. Undamped structures are more prone to vibration-originated problems such as high-cycle fatigue failures and extraneous noise emissions.

### BRIEF DESCRIPTION OF THE INVENTION

According to one embodiment, a vibration damper for an additively manufactured structure includes a structure at least partially formed with an additive manufacturing technique. Also included is a damping element embedded within the structure at an internal location of the structure.

In addition to one or more of the features described above, or as an alternative, further embodiments may include that the damping element comprises loose particles.

In addition to one or more of the features described above, or as an alternative, further embodiments may include that the damping element comprises powder.

In addition to one or more of the features described above, or as an alternative, further embodiments may include that the damping element comprises a resonator.

In addition to one or more of the features described above, or as an alternative, further embodiments may include that the resonator comprises a mass-spring arrangement.

In addition to one or more of the features described above, or as an alternative, further embodiments may include that the damping element comprises at least one thin film layer of fluid.

In addition to one or more of the features described above, or as an alternative, further embodiments may include that the damping element comprises a fluidic material, such as oil, disposed within at least one cavity.

In addition to one or more of the features described above, or as an alternative, further embodiments may include that the structure comprises a composite material having a host material and damped material integrally formed within the host material.

In addition to one or more of the features described above, or as an alternative, further embodiments may include that the damping element is integrally formed with a base material of the structure.

In addition to one or more of the features described above, or as an alternative, further embodiments may include that the structure is a helicopter component.

In addition to one or more of the features described above, or as an alternative, further embodiments may include that the helicopter component is one of a gear, a transmission casing, a gearbox, and a fuselage structure.

In addition to one or more of the features described above, or as an alternative, further embodiments may include that the additive manufacturing technique is at least one of direct metal laser sintering (DMLS), and electron beam melting (EBM).

In addition to one or more of the features described above, or as an alternative, further embodiments may include that the damping element is loosely disposed within the structure.

In addition to one or more of the features described above, or as an alternative, further embodiments may include a plurality of damping elements completely embedded within the structure.

According to another embodiment, a method of damping vibration of an additively manufactured component is provided. The method includes additively manufacturing a structure. The method also includes embedding at least one damping element within the structure at an internal location of the structure.

In addition to one or more of the features described above, or as an alternative, further embodiments may include that the damping element comprises at least one of loose particles, a resonator, at least one thin film layer of fluid, and a damped material integrally formed within a host material of a composite material.

### BRIEF DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 is a schematic illustration of a structure formed with an additive manufacturing technique having a damping element embedded therein according to one aspect of the invention;

FIG. 2 is a perspective view of the structure according to another aspect of the invention;

FIG. 3 is a sectional view of the structure according to another aspect of the invention;

FIG. 4 is a sectional view of the damping element according to an aspect of the invention;

FIG. 5 is a sectional view of the damping element according to another aspect of the invention;

FIG. 6 is a sectional view of the damping element according to another aspect of the invention;

FIG. 7 is a sectional view of the damping element according to another aspect of the invention;

FIG. 8 is an elevation view of the structure according to another aspect of the invention;

FIG. 9 is a sectional view of the damping element according to another aspect of the invention; and

FIG. 10 is a sectional view of the damping element according to an aspect of the invention.

### DETAILED DESCRIPTION OF THE INVENTION

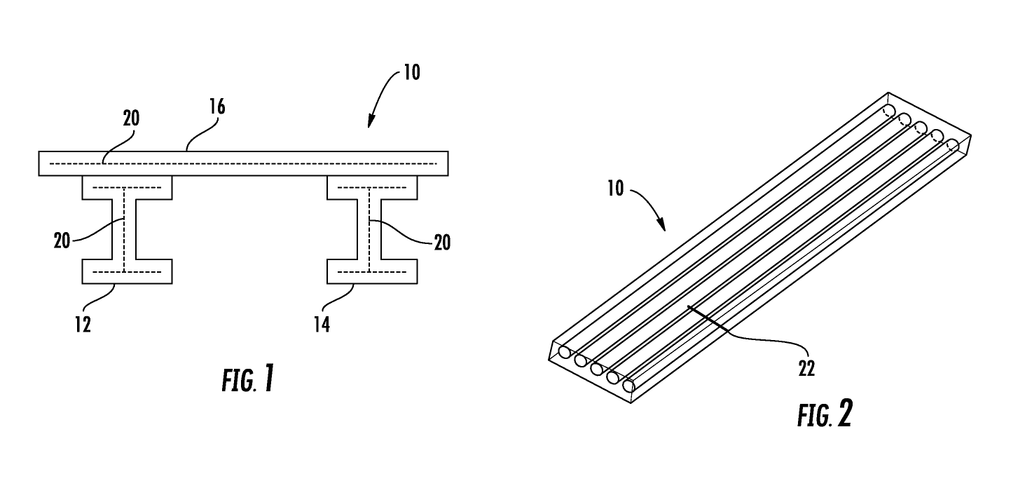

Referring to FIG. 1, generically illustrated is a structure 10 that is manufactured with at least one additive manufacturing technique. It is to be understood that the structure 10 may be formed completely with an additive manufacturing technique or in combination with a conventional process, such as forging, casting, extrusion, machining, etc. Although the structure 10 is illustrated as a first I-beam 12, a second I-beam 14 and a panel 16, it is to be appreciated that the structure 10 may be formed of any geometry and configured to be employed in numerous contemplated industries. One industry that particularly benefits from additively manufactured processes is the aerospace industry based on the desirability for lighter components. Lighter materials may be employed when forming additively manufactured components, thereby better addressing the aerospace industry's weight requirements. The lighter material has the effect of reduced impedance, thereby resulting in higher vibration and noise. Additionally, part counts are reduced based on the elimination of joints, which provide damping. As will be appreciated from the description herein, a damping element 20 that is embedded within the structure 10 provides a damping effect to counteract the otherwise undamped nature of the joint-free structure. It is to be understood that more than one damping element may be included within the structure 10.

A helicopter is an example of an application that employs the structure 10 that is additively manufactured. Numerous systems and structural assemblies of a helicopter may employ the structure 10 described herein. Gears, transmission casings, strut-supported gearboxes and fuselage structures are all exemplary portions of a helicopter that benefit from the structure 10 with the damping element 20 embedded therein. Noise reduction is achieved by implementation of the damping element 20 within the structure 10. Although the aerospace industry has been provided as an example, as noted above it is to be appreciated that any industry that desires vibration and noise reduction would benefit from the embodiments described herein.

As noted above, the structure 10 is manufactured by an additive manufacturing process. “Additive manufacturing” refers to making a three-dimensional (3D) object from a 3D model or other electronic data source primarily through additive processes in which successive layers of material are laid down or otherwise formed under computer control. The particular additive manufacturing technique employed to form the structure 10 will vary depending on the particular application in which the structure 10 is to be used. Exemplary techniques include sintering or melting of a material, such as direct metal laser sintering, and electron beam melting. Additionally, cold spray deposition, ultrasonic consolidation and laminated object manufacturing are all additive manufacturing techniques that may be employed to form the structure 10.

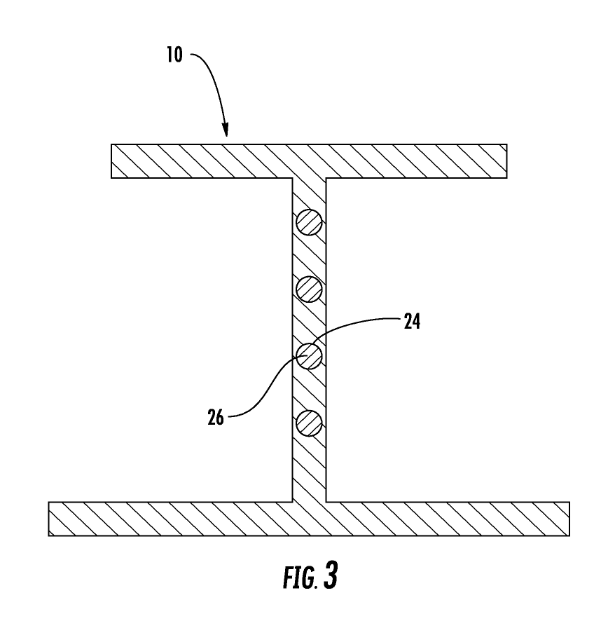

The additive manufacturing process may form the structure of FIG. 1 or alternate geometries, such as a beam (FIG. 2) or an I-beam (FIG. 3). These are merely illustrative embodiments of the structure 10 and it is to be understood that additive manufacturing processes may be used to form nearly any 3D object. The damping element 20 is schematically represented in FIG. 1 and is shown in more detail in FIGS. 2 and 3. The structure 10 of FIG. 2 includes at least one internal channel 22 that is formed therein. The channel(s) 22 is closed at the ends to retain the damping element therein. Formed or disposed within the channel(s) is the damping element 20, which may be powder loosely trapped therein, for example, with the powder being the damping element. Similarly, the damping element 20 in structure 10 of FIG. 3 comprises at least one internal cavity or pocket 24 formed at an internal location of the structure 10, where powder 26 is loosely located to form the damping element 20. During any of additive manufacturing processes, the damping element 20 is formed and completely embedded or encapsulated within the structure 10.

FIG. 4 illustrates the powder particles 26 in greater detail. The powder particles 26 of FIG. 4 are shown within a generic internal channel, cavity or the like 28, and may be loosely disposed within a structure having any geometry. The powder particles 26 provide friction damping based on their interaction with one another during motion of the structure 10 in which they are disposed. The term loosely disposed is employed to refer to the powder, however, it is to be appreciated that the degree to which the powder is packed may be adjusted to tune the damping of the structure 10. In other words, the powder may be provided in a compact manner to achieve different frictional effects and thereby damping. In particular, the amount of powder that fills the space will change the damping. For example, a space filled completely (e.g., 100% filled) will provide more damping that a space filled at 50%. The powder is included during the additive manufacturing process by “blowing” the powder into the channels without the energy source being on or at sufficient power levels to melt the powder in a laser applied process.

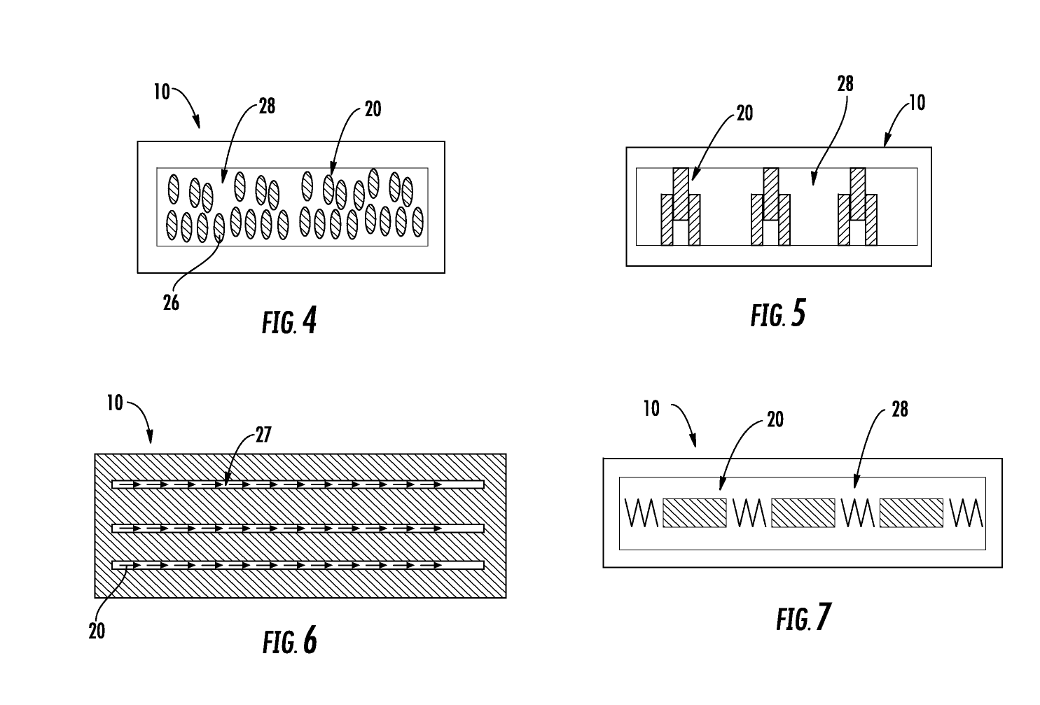

FIGS. 5-7 illustrate additional embodiments of the damping element 20 that may be embedded within the structure 10. FIG. 5 illustrates a friction and/or viscous damper 20 disposed within internal space 28 that relies on simply friction or includes a fluid therein to facilitate damping of the structure 10. FIG. 6 illustrates the structure 10 having thin channels 27 with trapped air inside which act as damping elements. A thin film of air interposed between two closely spaced surfaces provides viscous friction energy loss which damps vibrations. Alternatively, the channel(s) may also be filled with a more viscous fluid such as oil. FIG. 7 illustrates a resonator 20, such as an internal mass-spring system that provides vibration damping at resonance frequencies of the structure 10. FIG. 10 illustrates the damping element 20 in the form of a loosely interposed component disposed in the internal space 28 to move therein and rub the interior surface that defines the internal space 28 to provide friction damping.

Referring now to FIG. 8, an embodiment of the damping element 20 that is added on to the structure 10 is illustrated. In this embodiment, the damping element 20 may be a distinct material from that of the structure 10. To manufacture distinct components, an additive manufacturing process configured to form structures with multiple materials is required. During the process, the damping element 20 may be simply added on to the structure 10 as a coating or the like and then later embedded, if desired.

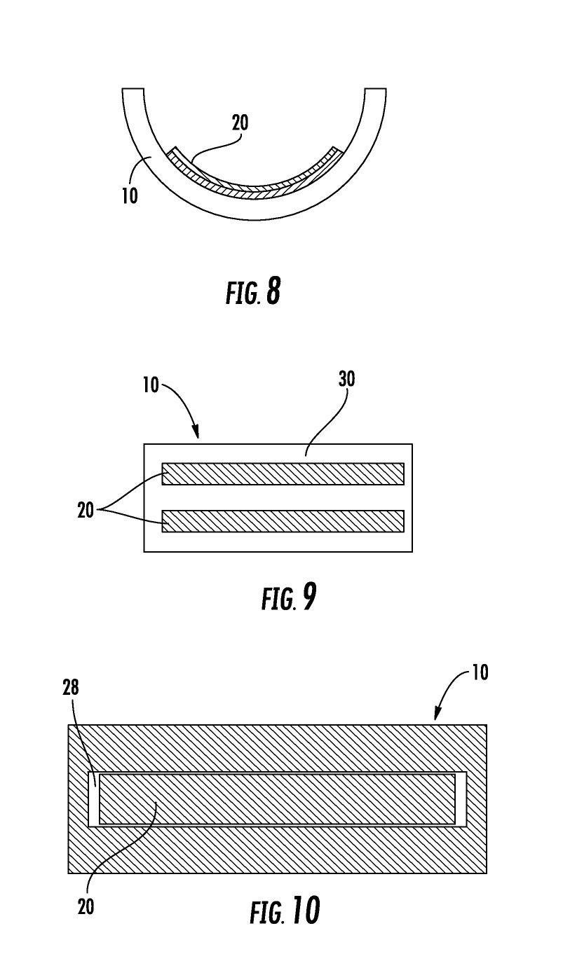

Referring to FIG. 9, another embodiment of the structure 10 and the damping element 20 is illustrated. The structure 10 is a composite structure formed with multiple materials. In particular, the composite structure is formed with a base or host material 30, such as metal, with damped material 20 embedded therein.

Advantageously, the embodiments of the structure 10 described herein may provide the benefits of an additively manufactured component, which achieving the benefits of a damped structure with the embedded damping element(s) 20. The damping element 20 is integrated therein, either as an integrally formed component or one simply located within an internal space of the structure 10, and may be tuned to control damping. Tuning involves controlling the size and location of the damping element 20, as well as the compactness in the case of the powder embodiments described above. The integration of damping directly into the structure streamlines the design and manufacturing process and possibly avoids costly redesigns in case of vibration problems, as the damping element itself may be modified or replaced easily in embodiments of the structure 10 that facilitate repeated opening and closing of the structure 10 to access the damping element 20. Additionally, external vibration mitigating devices are avoided, thereby saving space and improving the robustness and reliability of the structure.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A vibration damper for an additively manufactured structure comprising:
a structure at least partially formed with an additive manufacturing technique; and
a damping element embedded within the structure at an internal location of the structure.

2. The vibration damper of claim 1, wherein the damping element comprises loose particles.

3. The vibration damper of claim 1, wherein the damping element comprises powder.

4. The vibration damper of claim 1, wherein the damping element comprises a resonator.

5. The vibration damper of claim 4, wherein the resonator comprises a mass-spring arrangement.

6. The vibration damper of claim 1, wherein the damping element comprises at least one thin film layer of fluid.

7. The vibration damper of claim 1, wherein the structure comprises a composite material having a host material and damped material integrally formed within the host material.

8. The vibration damper of claim 1, wherein the damping element is integrally formed with a base material of the structure.

9. The vibration damper of claim 1, wherein the structure is a helicopter component.

10. The vibration damper of claim 9, wherein the helicopter component is one of a gear, a transmission casing, a gearbox, and a fuselage structure.

11. The vibration damper of claim 1, wherein the additive manufacturing technique is at least one of direct metal laser sintering (DMLS), and electron beam melting (EBM).

12. The vibration damper of claim 1, wherein the damping element is loosely disposed within the structure.

13. The vibration damper of claim 1, further comprising a plurality of damping elements completely embedded within the structure.

14. A method of damping vibration of an additively manufactured component comprising:
additively manufacturing a structure; and
embedding at least one damping element within the structure at an internal location of the structure.

15. The method of claim 14, wherein the damping element comprises at least one of loose particles, a resonator, at least one film layer of fluid, and a damped material integrally formed within a host material of a composite material.
